(19) United States
(12) Patent Application Publication
(10) Pub. No.: US 2018/0260852 A1
(43) Pub. Date: Sep. 13, 2018

(54) INFORMATION PROCESSING METHOD AND SERVER

(71) Applicant: Tencent Technology (Shenzhen) Company Limited, Shenzhen (CN)

(72) Inventors: Wa Ye, Shenzhen (CN); Zhenyu Xu, Shenzhen (CN); Yadi Xiao, Shenzhen (CN); Chengwei Lin, Shenzhen (CN)

(73) Assignee: Tencent Technology (Shenzhen) Company Limited, Shenzhen (CN)

(21) Appl. No.: 15/976,328

(22) Filed: May 10, 2018

Related U.S. Application Data
(63) Continuation of application No. PCT/CN2017/072015, filed on Jan. 22, 2017.

(30) Foreign Application Priority Data
Feb. 5, 2016 (CN) 201610083279.3

(51) Int. Cl. G06Q 30/02; H04W 4/02

(52) U.S. Cl. CPC G06Q 30/0261; G06F 17/3087; H04W 4/02; G06Q 30/0267

(57) ABSTRACT

This application discloses an information processing method and a server. The server provides an information service interface externally and performs information interaction with at least one third-party application system through the information service interface. The method includes: sending, to a user terminal, electronic information obtained from the third-party application system through the information service interface, the electronic information including a numerical value and provider information; obtaining at least one of first geographical location information or first time information reported by the user terminal; and determining whether one of the at least one of the first geographical location information or the first time information reported by the user terminal satisfies an adjustment condition, and if yes, updating the numerical value in the electronic information, and sending the updated numerical value of the electronic information to the user terminal.

### RELATED APPLICATION

This application is a continuation of International Application No. PCT/CN2017/072015, filed on Jan. 22, 2017, which claims priority to Chinese Patent Application No. 201610083279.3, entitled “INFORMATION PROCESSING METHOD AND SERVER” filed on Feb. 5, 2016. The entire disclosures of the prior applications are hereby incorporated by reference in their entirety.

### FIELD OF THE TECHNOLOGY

This application relates to communications technologies.

### BACKGROUND OF THE DISCLOSURE

Information interaction is frequently used in daily life. Application scenarios of the information interaction include, for example, the following life service scenarios. When shopping in a supermarket, a user may use a shopping card provided by the supermarket to buy a commodity. When going to a gas station, the user may use a gas card. With the development of Internet technologies and intelligent terminals, information related to the life service scenarios not only includes consumption by using a physical card, but also includes consumption by using a virtual card. A specific implementation of the virtual card is a card. A new channel for information interaction between a first user terminal (for example, a merchant) providing life services and a second user terminal (for example, a consumer) using the life services may be established by using the card. In the new information interaction mechanism, in addition to being performed between the first user terminal (for example, the merchant) and the second user terminal (for example, the consumer), the information interaction may also be performed among multiple second user terminals (for example, the consumers), that is, information can be shared by using multiple interaction modes.

Currently, information is shared by using the foregoing interaction modes. A card is issued with a fixed amount. However, in a process of pushing the card to a user, the user may be inaccurately located, or the user may neglect to use the card. Consequently, the information cannot be shared continuously. That is, after the user collects the card, if the card is used, a message that the card is used is pushed to the user. If the card is not used, the card may expire. Consequently, the processing efficiency and the response speed of the information sharing are not high. However, for this problem, there is no effective solution in the related technologies yet.

### SUMMARY

In view of this, embodiments of this application provide an information processing method and a server, to improve the processing efficiency and the response speed of information sharing.

The technical solution of the embodiments of this application is implemented as follows.

In one embodiment of the present disclosure, there is provided an information processing method that includes:

sending, to a user terminal, electronic information obtained from the third-party application system through the information service interface, the electronic information including a numerical value information and provider information;

obtaining at least one of first geographical location information or first time information reported by the user terminal; and

determining whether one of the at least one of the first geographical location information or the first time information reported by the user terminal satisfies an adjustment condition, updating, when one of the at least one of the first geographical location information or the first time information satisfies the adjustment condition, the numerical value in the electronic information, and sending the updated numerical value of the electronic information to the user terminal.

In the above-described embodiment, the determining includes:

obtaining second geographical location information of the provider, and obtaining distance between the provider and the user terminal according to the first geographical location information of the user terminal and the second geographical location information of the provider; and

determining, whether the distance is within a preset distance range.

In the above-described embodiment, the updating includes:

decreasing, when the distance is greater than a first threshold of the adjustment condition, the numerical value; and

increasing, when the distance is less than a second threshold of the adjustment condition, the numerical value.

In the above-described embodiment, the sending includes:

sending the electronic information to a first user terminal and a second user terminal that are logged into the server respectively, the electronic information sent to the first user terminal including a first numerical value and the electronic information sent to the second user terminal including a second numerical value;

the determining includes

obtaining first geographical location information of the first user terminal and first geographical location information of the second user terminal, respectively;

obtaining second geographical location information of the provider, and obtaining a first distance according to the first geographical location information of the first user terminal and

the second geographical location information of the provider; and obtaining a second distance according to the first geographical location information of the second user terminal and the second geographical location information of the provider; and

the updating includes

updating, when the first distance is greater than the second distance, the first numerical value and the second numerical value so that a difference between the first numerical value and the updated first numerical value is lower than a difference between the second numerical value and the updated second numerical value; and

updating, when the first distance is less than the second distance, the first numerical value and the second numerical value so that a difference between the first numerical value and the updated first numerical value is higher than a difference between the second numerical value and the updated second numerical value.

In the above-described embodiment, the determining includes:

determining a validity period of the electronic information according to a permitted start time T0 for using the electronic information and a permitted expiry time Tn for using the electronic coupon information, n being a positive integer greater than 1; and

determining, whether the first time information reported by the user terminal is within the validity period.

In the above-described embodiment, the updating includes:

obtaining first time information Ti for using the electronic information when a user is logged into the server, i being a positive integer greater than 1; and

increasing, when Ti approaches T0, the numerical value; and

decreasing, when Ti approaches Tn, the numerical value.

In the above-described embodiment, the updating includes:

obtaining second geographical location information of the provider, and obtaining a distance according to the first geographical location information of the user terminal and the second geographical location information of the provider;

determining a validity period of the electronic information according to a permitted start time T0 for using the electronic information and a permitted expiry time Tn for using the electronic information, n being a positive integer greater than 1; and

decreasing, when the distance is greater than a first threshold of the adjustment condition and first time information Ti for using the electronic information by a user logged into the server approaches Tn, the numerical value; or

increasing, when the distance is less than a second threshold of the adjustment condition and first time information Ti for using the electronic information by a user logged into the server approaches T0, the numerical value.

In another embodiment of the present disclosure, there is provided a server including circuitry. The circuitry is configured to

send, to a user terminal, electronic information obtained from a third-party application system through an information service interface, the electronic information including a numerical value and provider information;

obtain at least one of first geographical location information of the user terminal or first time information reported by the user terminal; and

determine whether one of the at least one of the first geographical location information or the first time information reported by the user terminal satisfies an adjustment condition;

update when one of the at least one of the first geographical location information or the first time information satisfies the adjustment condition, the numerical value in the electronic information the numerical value in the electronic information; and

send the updated numerical value of the electronic information to the user terminal.

In the above-described embodiment, the circuitry is further configured to:

obtain second geographical location information of the provider, and obtain a distance between the provider and the user terminal according to the first geographical location information of the user terminal and the second geographical location information of the provider; and

determine, whether the distance between the provider and the user terminal is within a preset distance range.

In the above-described embodiment, the circuitry is further configured to:

decrease, when the distance is greater than a first threshold of the adjustment condition, the numerical value; and

increase, when the distance is less than a second threshold of the adjustment condition, the numerical value.

In the above-described embodiment, the circuitry is further configured to:

send the electronic information to a first user terminal and a second user terminal that are logged into the server respectively, the electronic information sent to the first user terminal including a first numerical value and the electronic information sent to the second user terminal including a second numerical value;

obtain first geographical location information of the first user terminal and first geographical location information of the second user terminal, respectively;

obtain second geographical location information of the provider, and obtain a first distance between the provider and the first user terminal according to the first geographical location information of the first user terminal and the second geographical location information of the provider; and

obtain a second distance between the provider and the second user terminal according to the first geographical location information of the second user terminal and the second geographical location information of the provider; and

update, when the first distance is greater than the second distance, the first numerical value and the second numerical value so that a difference between the first numerical value and the updated first numerical value is lower than a difference between the second numerical value and the updated second numerical value; and

update, when the first distance is less than the second distance, the first numerical value and the second numerical value so that a difference between the first numerical value and the updated first numerical value is higher than a difference between the second numerical value and the updated second numerical value.

In the above-described embodiment, the circuitry is further configured to:

determine a validity period of the electronic information according to a permitted start time T0 for using the electronic information and a permitted expiry time Tn for using the electronic information, n being a positive integer greater than 1; and

determine, whether the first time information reported by the user terminal is within the validity period.

In the above-described embodiment, the circuitry is further configured to:

obtain first time information Ti for using the electronic information by a user logged into the server, i being a positive integer greater than 1; and

increase, when Ti approaches T0, the numerical value; and

decrease, when Ti approaches Tn, the numerical value.

In the above-described embodiment, the circuitry is further configured to:

obtain second geographical location information of the provider, and obtain a distance between the user terminal and the provider according to the first geographical location information of the user terminal and the second geographical location information of the provider; and

determine a validity period of the electronic information according to a permitted start time T0 for using the electronic information and a permitted expiry time Tn for using the electronic information, n being a positive integer greater than 1; and

decrease, when the distance is greater than a first threshold of the adjustment condition and first time information Ti for using the electronic information by a user logged into the server approaches Tn, the numerical value; and

increase, when the distance is less than a second threshold of the adjustment condition and first time information Ti for using the electronic information by a user logged into the server approaches T0, the numerical value.

This application further provides a non-transitory computer-readable storage medium storing a computer program, the computer program being used for performing a method that includes

obtaining at least one of first geographical location information of the user terminal or first time information reported by the user terminal;

determining whether one of the at least one of the first geographical location information or the first time information reported by the user terminal satisfies an adjustment condition;

updating, when one of the at least one of the first geographical location information or the first time information satisfies the adjustment condition, the numerical value in the electronic information; and

sending the updated numerical value of the electronic information to the user terminal.

### BRIEF DESCRIPTION OF THE DRAWINGS

FIG. 1 is a schematic diagram of each hardware entity performing information interaction according to an embodiment of this application;

FIG. 2 is a schematic diagram of an implementation procedure according to an embodiment of this application;

FIG. 3 is a schematic diagram of another implementation procedure according to an embodiment of this application;

FIG. 4 is a schematic diagram of another implementation procedure according to an embodiment of this application;

FIG. 5 is a schematic diagram of a composition structure according to an embodiment of this application;

FIG. 6 is a schematic diagram of a hardware structure according to an embodiment of this application;

FIG. 7 is a schematic diagram of implementing a preferential process to which an application scenario is applied according to an embodiment of this application; and

FIG. 8 is a schematic structural diagram of hardware of a server according to an embodiment of this application.

### DESCRIPTION OF EMBODIMENTS

The following further describes implementation of the technical solution in detail with reference to the accompanying drawings.

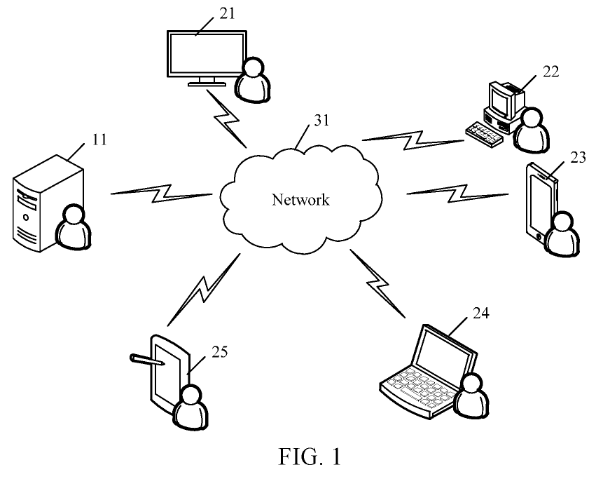

FIG. 1 is a schematic diagram of each hardware entity performing information interaction according to an embodiment of this application. FIG. 1 includes one or more servers, the server 11 in FIG. 1 being merely exemplary, terminal devices 21 to 25, and a network 31. The network 31 includes network entities such as a router and a gateway. The terminal devices 21 to 25 perform information interaction with the server 11 by using a wired network or a wireless network. The terminal device 21 to 25 may also perform information interaction with each other. Each of the terminal devices 21 to 25 can download an application and/or an application update data packet and/or data information or service information related to an application from the network 31. The terminal devices are shown in FIG. 1, including types such as a mobile phone 23, a tablet computer or a PDA 25, a desktop computer 22, a PC 24, and an all-in-one machine 21. Various applications required by a user are installed in the terminal devices 21 to 25, for example, an application having a social function (for example, WeChat) or an application having an entertainment function (for example, a video application, an audio playback application, a game application or a reader), or for another example, an application having a service function (for example, a map navigation application or a group buying application).

Based on the system shown in FIG. 1, for example, information interacted is card information or coupon information. According to this embodiment of this application, each of the terminal devices 21 to 25 may be divided into two types, respectively represented as a first terminal (for example, a terminal corresponding to a sender sending the card information or coupon information such as a terminal which a merchant logs into) and a second terminal (for example, a terminal corresponding to a receiver receiving the card information or coupon information such as a terminal which a common user logs into, the user using services provided by the merchant by using the card information or coupon information sent by the merchant based on a platform such as WeChat). The first terminal and the second terminal interact with each other, or may perform information interaction with the server.

According to this embodiment of this application, on a first terminal side, for example, a terminal which the merchant logs into, card information or coupon information is set. The card information or coupon information may be directly sent to a second terminal. Alternatively, the card information or coupon information may be collectively managed by a platform such as WeChat, and the platform such as WeChat sends the card information or coupon information to a second terminal. The server (or referred to as a platform such as WeChat) sends electronic coupon information set by the first terminal to the second terminal, the electronic coupon information having a first information amount. The server (or referred to as a platform such as WeChat) obtains an information amount adjustment policy (the information amount adjustment policy may be configured by the terminal to which the merchant logs into and is then collectively managed by the server, or may be generated by the server after the server responds according to a request sent by the terminal to which the merchant logs into) associated with the electronic coupon information; detects whether location information between the first terminal and the second terminal and/or time information of using the electronic coupon information by the second terminal satisfies the information amount adjustment policy (the information amount adjustment policy may be divided into a location information policy and a time information policy, or may be a combination thereof), and if yes, updates and adjusts the first information amount in the electronic coupon information to a second information amount, and notifies the second terminal of a message that an information amount of the electronic coupon information has been adjusted to the second information amount. On a second terminal side, for example, a terminal which the common user logs into, various services provided by the first terminal (for example, the terminal which the merchant logs into) are used according to the card information or coupon information whose information amount is updated.

The example of FIG. 1 is only an instance of a system architecture for implementing the embodiments of this application, and does not constitute any limitation thereto. The embodiments of this application are described based on the system architecture.

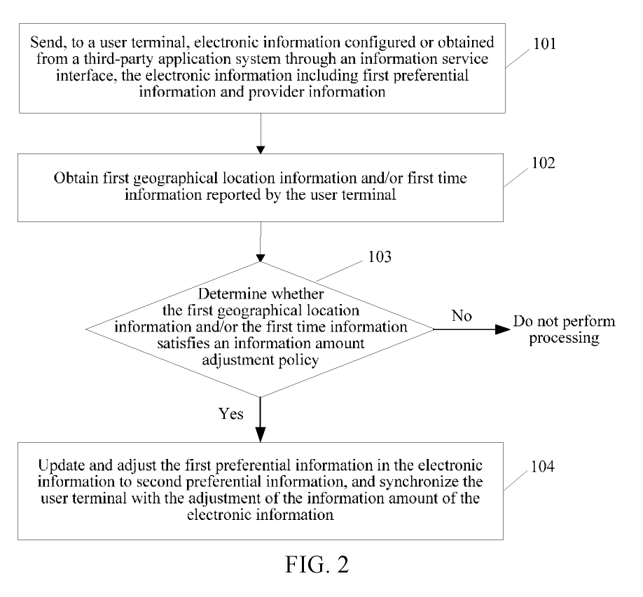

An embodiment of this application discloses an information processing method of a server. The server provides an information service interface externally and performs information interaction with at least one third-party application system through the information service interface. The third-party application system is an application system (for example, a point of sale (POS) system) of a merchant. As shown in FIG. 2, the method includes the following steps:

Step 101: Send, to a user terminal, electronic coupon information or other electronic coupon information) configured or obtained from the third-party application system through the information service interface, the electronic coupon information including first preferential information, such as a numerical value, and provider information.

Here, in this step, a first terminal (for example, a terminal which the merchant logs into) sets card information or coupon information. The card information or coupon information may be directly sent to a second terminal (for example, a terminal which a common user logs into). Alternatively, the card information or coupon information may be collectively managed by a platform such as WeChat, and the platform such as WeChat sends the card information or coupon information to a second terminal (for example, a terminal which a common user logs into). The electronic coupon information has a first information amount (or referred to as an initial amount), for example, a voucher of 30 RMB of a coffee shop and a coupon of 20% discount.

It is noted herein that the first terminal is a merchant providing a service and being not limited to an advertiser. It is noted that, an electronic device used by the merchant in this specification to provide a service may be a terminal, a server, or a system architecture including a terminal and a server.

Step 102: Obtain at least one of first geographical location information or first time information reported by the user terminal.

Step 103: Determine whether one of the at least one of the first geographical location information or the first time information reported by the user terminal satisfies an information amount adjustment policy, such as an adjustment condition, and if yes, perform step 104, or if not, do not perform processing.

Here, the information amount adjustment policy associated with the electronic coupon information may be divided into two parts, respectively time and space. The electronic coupon information may be set according to one of the two parts, or may be set with reference to both the two parts. 1) With respect to the time, the first terminal, for example, a merchant, may set a start time and an expiry time before issuing cards or coupons. Within the validity period, a discount that can be granted to a user becomes smaller over time. That is, a time closer to the start time of using the card or the coupon indicates a larger discount granted to the user, and a time closer to the expiry time of using the card or the coupon indicates a smaller discount granted to the user. 2) With respect to the space, the server may first calculate a distance between the second terminal (for example, the terminal which a common user logs into) and the first terminal (for example, the terminal which the merchant issuing the cards or coupons logs into), and then delivers different discounts according to different distances. For example, a discount granted to a user relatively distant from the merchant is greater than that granted to a user relatively close to the merchant.

Step 104: Update the first preferential information such as the numerical value in the electronic coupon information to second preferential information, and synchronize the second terminal with the adjustment of the information amount of the electronic coupon information, for example, synchronously display an updated coupon through an APP interface of a user. For example, the synchronization is performed by sending the second preferential information (e.g., the updated numerical value) to the second terminal.

The first information amount herein is the voucher of 30 RMB, and the numerical value may be updated to a voucher of 50 RMB. After the information amount has been updated and adjusted, an amount of the voucher is increased. Alternatively, the first information amount is a discount coupon, being specifically a first discount of 20% discount, and the updated numerical amount is specifically a second discount of 50% discount. After the information amount has been updated and adjusted, the discount becomes larger.

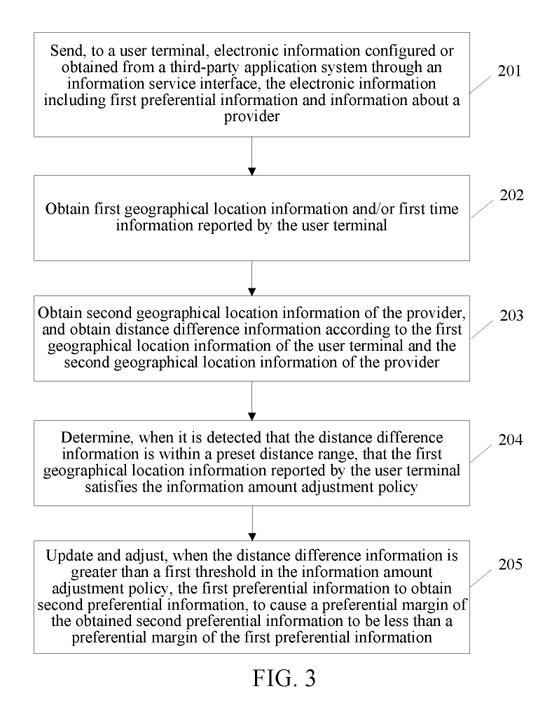

An embodiment of this application provides an information processing method applied to a server. The server provides an information service interface externally and performs information interaction with at least one third-party application system through the information service interface. The third-party application system is an application system (for example, a POS system) of a merchant. As shown in FIG. 3, the method includes the following steps:

Step 201: Send, to a user terminal, electronic coupon information, or other electronic information. configured or obtained from the third-party application system through the information service interface, the electronic coupon information including first preferential information and information about a provider.

Here, in this step, a first terminal (for example, a terminal which the merchant logs into) sets card information or coupon information. The card information or coupon information may be directly sent to a second terminal (for example, a terminal which a common user logs into). Alternatively, the card information or coupon information may be collectively managed by a platform such as WeChat, and the platform such as WeChat sends the card information or coupon information to a second terminal (for example, a terminal which a common user logs into). The electronic coupon information has a first information amount (or referred to as an initial amount), for example, a voucher of 30 RMB of a coffee shop and a coupon of 20% discount.

Step 202: Obtain first geographical location information and/or first time information reported by the user terminal.

Step 203: Obtain second geographical location information of the provider, and obtain distance difference information according to the first geographical location information of the user terminal and the second geographical location information of the provider.

Step 204: Determine, when it is detected that the distance difference information is within a preset distance range, that the first geographical location information of the user terminal satisfies the information amount adjustment policy, such as the adjustment condition, and perform step 205.

Here, the information amount adjustment policy associated with the electronic coupon information may be divided into two parts, respectively time and space. The electronic coupon information may be set according to one of the two parts, or may be set with reference to both the two parts. 1) With respect to the time, the first terminal, for example, a merchant, may set a start time and an expiry time before issuing cards or coupons. Within the validity period, a discount that can be granted to a user becomes smaller over time. That is, a time closer to the start time of using the card or the coupon indicates a larger discount granted to the user, and a time closer to the expiry time of using the card or the coupon indicates a smaller discount granted to the user. 2) With respect to the space, the server may first calculate a distance between the second terminal (for example, the terminal which a common user logs into) and the first terminal (for example, the terminal which the merchant issuing the cards or coupons logs into), and then delivers different discounts according to different distances. For example, a discount granted to a user relatively distant from the merchant is less than that granted to a user relatively close to the merchant.

Here, with reference to steps 203 and 204, the first terminal may be a merchant of a Sichuan hot pot restaurant within the Wudaokou trading area. A potential consumer of the second terminal is driving toward the Wudaokou trading area. When a distance between the potential consumer and the Wudaokou trading area approaches a threshold or when the consumer already enters the Wudaokou trading area, the distance is within the distance range of the information amount adjustment policy, and a corresponding information amount sent to the potential consumer of the second terminal may be adjusted. That is, the potential consumer is at least in a trading area, or in an adjacent trading area. Potential consumers of the second terminal that are very distant from the trading area or that are very close to the trading area are not considered because of the distance range. Potential consumers that are very close to the trading area have consumption demands, and no recommendation needs to be made by the merchant. For those that are very distant from the trading area, there is not much significance in recommending the merchant, because they are less likely to go to the merchant.

Step 205: Update and adjust, when the distance difference information is greater than a first threshold in the information amount adjustment policy, the first preferential information to obtain second preferential information, to cause a preferential margin of the obtained second preferential information to be less than a preferential margin of the first preferential information. For example, a first amount is a voucher of 50 RMB. Because a user is distant from a merchant, the first amount is updated to a voucher of 20 RMB, and an amount of the voucher is decreased. Alternatively, the first amount is a discount coupon, and a first discount is 50% discount. Because a user is distant from a merchant, 10% discount is granted, and the discount becomes smaller. This embodiment is described for a situation in which an absolute distance between a user and a merchant is calculated, and the user is determined as being close to the merchant based on an absolute distance.

Here, step 205 may alternatively be step 205′: Update and adjust, when the distance difference information is less than a second threshold in the information amount adjustment policy, the first preferential information to obtain second preferential information, to cause a preferential margin of the obtained second preferential information to be greater than a preferential margin of the first preferential information. For example, a first amount is a voucher of 30 RMB. Because a user is close to a merchant, the first amount is updated to a voucher of 50 RMB, and an amount of the voucher is increased. Alternatively, the first amount is a discount coupon, and a first discount is 20% discount. Because a user is close to a merchant, 50% discount is granted, and the discount becomes larger. This embodiment is described for a situation in which an absolute distance between a user and a merchant is calculated, and the user is determined as being close to the merchant based on an absolute distance.

The first threshold and the second threshold may be the same or may be different.

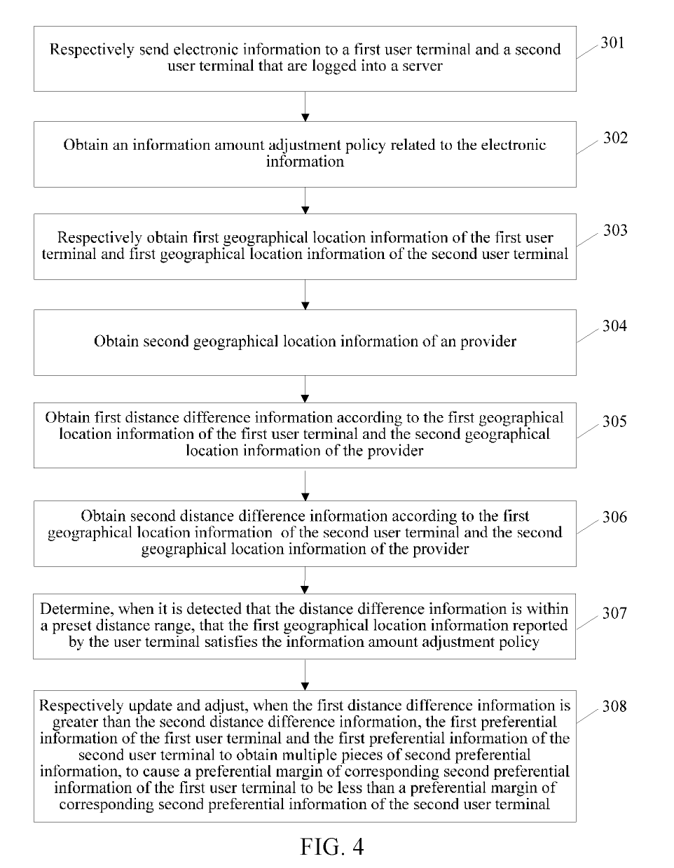

An embodiment of this application provides an information processing method applied to a server. The server provides an information service interface externally and performs information interaction with at least one third-party application system through the information service interface. The third-party application system is an application system (for example, a POS system) of a merchant. As shown in FIG. 4, the method includes the following steps:

Step 301: Respectively send electronic coupon information, or other electronic information, to a first user terminal and a second user terminal that log into the server.

A first user and a second user herein may be related or unrelated, and may be users sharing a card or a coupon, or may be users respectively using different cards or coupons. Both the first user and the second user use an application (for example, WeChat or QQ) of a second terminal to send, receive, share, and forward a card or a coupon provided by a merchant, and use a service provided by the merchant according to the card or coupon provided by the merchant.

Here, in this step, a first terminal (for example, a terminal which the merchant logs into) sets card information or coupon information. The card information or coupon information may be directly sent to a second terminal (for example, a terminal which a common user logs into). Alternatively, the card information or coupon information may be collectively managed by a platform such as WeChat, and the platform such as WeChat sends the card information or coupon information to a second terminal (for example, a terminal which a common user logs into). The electronic coupon information has a first information amount (or referred to as an initial amount), for example, a voucher of 30 RMB of a coffee shop and a coupon of 20% discount.

Step 302: Obtain an information amount adjustment policy, such as an adjustment condition, associated with the electronic coupon information.

Here, the information amount adjustment policy associated with the electronic coupon information may be divided into two parts, respectively time and space. The electronic coupon information may be set according to one of the two parts, or may be set with reference to both the two parts. 1) With respect to the time, the first terminal, for example, a merchant, may set a start time and an expiry time before issuing cards or coupons. Within the validity period, a discount that can be granted to a user becomes smaller over time. That is, a time closer to the start time of using the card or the coupon indicates a larger discount granted to the user, and a time closer to the expiry time of using the card or the coupon indicates a smaller discount granted to the user. 2) With respect to the space, the server may first calculate a distance between the second terminal (for example, the terminal which a common user logs into) and the first terminal (for example, the terminal which the merchant issuing the cards or coupons logs into), and then delivers different discounts according to different distances. For example, a discount granted to a user relatively distant from the merchant is greater than that granted to a user relatively close to the merchant.

Step 303: Respectively obtain first geographical location information of the first user terminal and first geographical location information of the second user terminal.

Step 304: Obtain second geographical location information of an provider.

Step 305: Obtain first distance difference information according to the first geographical location information of the first user terminal and the second geographical location information of the provider.

Step 306: Obtain second distance difference information according to the first geographical location information of the second user terminal and the second geographical location information of the provider.

Step 307: Determine, when it is detected that the distance difference information is within a preset distance range, that the first geographical location information reported by the user terminal satisfies the information amount adjustment policy, and perform step 308.

Here, with reference to steps 303 to 307, the first terminal may be a merchant of a Sichuan hot pot restaurant within the Wudaokou trading area. A potential consumer of the second terminal is driving toward the Wudaokou trading area. When a distance between the potential consumer and the Wudaokou trading area approaches a threshold or when the consumer already enters the Wudaokou trading area, the distance is within the distance range of the information amount adjustment policy, and a corresponding information amount sent to the potential consumer of the second terminal may be adjusted. That is, the potential consumer is at least in a trading area, or in an adjacent trading area. Potential consumers of the second terminal that are very distant from the trading area or that are very close to the trading area are not considered because of the distance range. Potential consumers that are very close to the trading area have consumption demands, and no recommendation needs to be made by the merchant. For those that are very distant from the trading area, there is not much significance in recommending the merchant, because they are less likely to go to the merchant.

Step 308: Respectively update and adjust, when the first distance difference information is greater than the second distance difference information, the first preferential information, such as a first numerical value, of the first user terminal and the first preferential information, such as a second numerical value, of the second user terminal to obtain multiple pieces of second preferential information, to cause a preferential margin of corresponding second preferential information of the first user terminal to be less than a preferential margin of corresponding second preferential information of the second user terminal. For example, a first information amount of the first user is a voucher of 30 RMB, and an first information amount of the second user is a voucher of 20 RMB. Because the first user is more distant from the merchant than the second user is, the first information amount of the first user is adjusted to be a voucher of 10 RMB, and the first information amount of the second user is adjusted to be a voucher of 50 RMB. Alternatively, the first information amount is a discount coupon, and a discount is also adjusted according to the adjustment policy. Details are not described again. This embodiment is described for a situation in which a relative distance between two users and a same merchant is calculated, and the user is determined as being distant from the merchant based on the relative distance.

Here, step 308 may alternatively be step 308′: Respectively update and adjust, when the first distance difference information is less than the second distance difference information, the first preferential information of the first user terminal and the first preferential information of the second user terminal to obtain multiple pieces of second preferential information, to cause a preferential margin of corresponding second preferential information of the first user terminal to be greater than a preferential margin of corresponding second preferential information of the second user terminal.

Based on the foregoing three embodiments, in an implementation of the embodiments of this application, the determining whether the first time information reported by the user terminal satisfies the information amount adjustment policy includes: determining a validity period of the electronic coupon information according to a permitted start time T0 for using the electronic coupon information and a permitted expiry time Tn for using the electronic coupon information, n being a positive integer greater than 1; and determining, when it is detected that the first time information reported by the user terminal is within the validity period, that the first time information reported by the user terminal satisfies the information amount adjustment policy.

Based on the foregoing three embodiments, in an implementation of the embodiments of this application, the updating and adjusting the first preferential information in the electronic coupon information to second preferential information includes: obtaining first time information Ti for using the electronic coupon information by a user logged into the server, i being a positive integer greater than 1; and updating and adjusting, if Ti approaches T0, the first preferential information to obtain second preferential information, to cause a preferential margin of the obtained second preferential information to be greater than a preferential margin of the first preferential information; or updating and adjusting, if Ti approaches Tn, the first preferential information to obtain second preferential information, to cause a preferential margin of the obtained second preferential information to be less than a preferential margin of the first preferential information.

Based on the foregoing three embodiments, in an implementation of the embodiments of this application, a time closer to the start time for using a coupon indicates a larger discount. For example, a first information amount is a voucher of 30 RMB, and a second information amount is a voucher of 50 RMB. An amount of the voucher is increased. Alternatively, the coupon is a discount coupon, and a first discount is 20% discount. Because a time for using the coupon approaches the start time of the coupon, the discount becomes larger, and the first discount is adjusted to 50% discount. Further, an implementation of the embodiments of this application further includes: obtaining a time Tj for using the electronic coupon information by a second user logged into the first terminal, j being a positive integer greater than 1; and granting a voucher amount or discount to the coupon used at Ti greater than that granted to the coupon used at Tj if Ti<Tj, that is, Ti is closer to the start time of the coupon than Tj is.

Based on the foregoing three embodiments, in an implementation of the embodiments of this application, when the first geographical location information and the first time information reported by the user terminal satisfy the information amount adjustment policy, the updating and adjusting the first preferential information in the electronic coupon information to second preferential information includes: obtaining second geographical location information of the provider, and obtaining distance difference information according to the first geographical location information of the user terminal and the second geographical location information of the provider; determining a validity period of the electronic coupon information according to a permitted start time T0 for using the electronic coupon information and a permitted expiry time Tn for using the electronic coupon information, n being a positive integer greater than 1; and updating and adjusting, when the distance difference information is greater than a first threshold in the information amount adjustment policy and first time information Ti for using the electronic coupon information by a user logged into the server approaches Tn, the first preferential information to obtain second preferential information, to cause a preferential margin of the obtained second preferential information to be less than a preferential margin of the first preferential information; or updating and adjusting, when the distance difference information is less than a second threshold in the information amount adjustment policy and first time information Ti for using the electronic coupon information by a user logged into the server approaches T0, the first preferential information to obtain second preferential information, to cause a preferential margin of the obtained second preferential information to be greater than a preferential margin of the first preferential information.

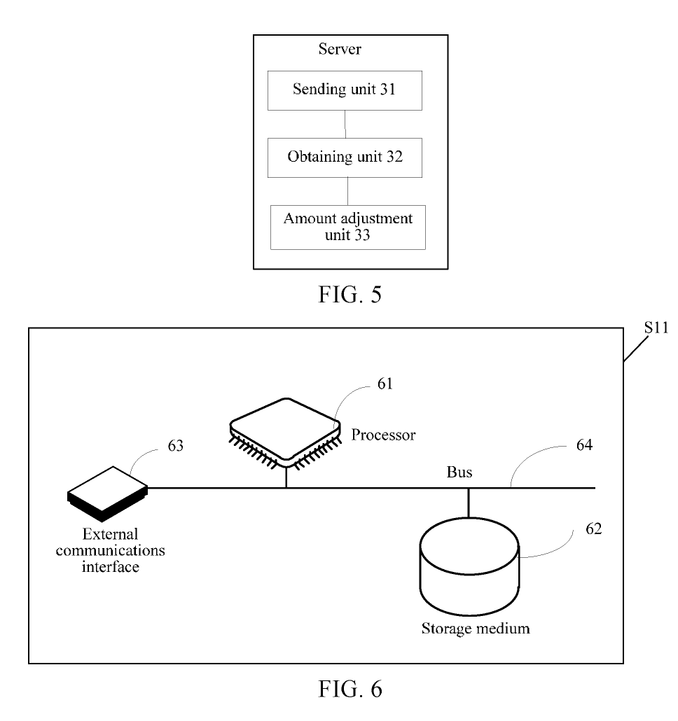

An embodiment of this application provides a server. As shown in FIG. 5, the server provides an information service interface externally and performs information interaction with at least one third-party application system through the information service interface. The server includes:

a sending unit 31, configured to send, to a user terminal, electronic coupon information configured or obtained from the third-party application system through the information service interface, the electronic coupon information including first preferential information and information about a provider; an obtaining unit 32, configured to obtain first geographical location information and/or first time information reported by the user terminal; and an amount adjustment unit 33, configured to: determine whether the first geographical location information and/or the first time information reported by the user terminal satisfies an information amount adjustment policy, and if yes, update and adjust the first preferential information in the electronic coupon information to second preferential information, and synchronize the second terminal with the adjustment of the information amount of the electronic coupon information.

During actual application of the embodiments of this application, a first terminal (for example, a terminal which the merchant logs into) sets card information or coupon information. The card information or coupon information may be directly sent to a second terminal (for example, a terminal which a common user logs into). Alternatively, the card information or coupon information may be collectively managed by a platform such as WeChat, and the platform such as WeChat sends the card information or coupon information to a second terminal (for example, a terminal which a common user logs into). The electronic coupon information has a first information amount (or referred to as an initial amount), for example, a voucher of 30 RMB of a coffee shop and a coupon of 20% discount. The information amount adjustment policy associated with the electronic coupon information may be divided into two parts, respectively time and space. The electronic coupon information may be set according to one of the two parts, or may be set with reference to both the two parts. 1) With respect to the time, the first terminal, for example, a merchant, may set a start time and an expiry time before issuing cards or coupons. Within the validity period, a discount that can be granted to a user becomes smaller over time. That is, a time closer to the start time of using the card or the coupon indicates a larger discount granted to the user, and a time closer to the expiry time of using the card or the coupon indicates a smaller discount granted to the user. 2) With respect to the space, the server may first calculate a distance between the second terminal (for example, the terminal which a common user logs into) and the first terminal (for example, the terminal which the merchant issuing the cards or coupons logs into), and then delivers different discounts according to different distances. For example, a discount granted to a user relatively distant from the merchant is less than that granted to a user relatively close to the merchant.

When the amount adjustment unit is used for performing adjustment, for example, the first information amount is the voucher of 30 RMB, and the first information amount may be updated to a voucher of 50 RMB. After the information amount has been updated and adjusted, an amount of the voucher is increased. Alternatively, the first information amount is a discount coupon, being specifically a first discount of 20% discount, and the second information amount is specifically a second discount of 50% discount. After the information amount has been updated and adjusted, the discount becomes larger.

In an implementation of the embodiments of this application, the amount adjustment unit is further configured to: obtain second geographical location information of the provider, and obtain distance difference information according to the first geographical location information of the user terminal and the second geographical location information of the provider; and when it is detected the distance difference information is within a preset distance range, determine that the first geographical location information reported by the user terminal satisfies the information amount adjustment policy.

In an implementation of the embodiments of this application, the amount adjustment unit is further configured to: update and adjust, when the distance difference information is greater than a first threshold in the information amount adjustment policy, the first preferential information to obtain second preferential information, to cause a preferential margin of the obtained second preferential information to be less than a preferential margin of the first preferential information; or update and adjust, when the distance difference information is less than a second threshold in the information amount adjustment policy, the first preferential information to obtain second preferential information, to cause a preferential margin of the obtained second preferential information to be greater than a preferential margin of the first preferential information.

In an implementation of the embodiments of this application, the sending unit is further configured to respectively send the electronic coupon information to a first user terminal and a second user terminal that log in to the server. The obtaining unit is further configured to: respectively obtain first geographical location information of the first user terminal and first geographical location information of the second user terminal; obtain second geographical location information of the provider, and obtain first distance difference information according to the first geographical location information of the first user terminal and the second geographical location information of the provider; and obtain second distance difference information according to the first geographical location information of the second user terminal and the second geographical location information of the provider. The amount adjustment unit is further configured to: respectively update and adjust, when the first distance difference information is greater than the second distance difference information, the first preferential information of the first user terminal and the first preferential information of the second user terminal to obtain multiple pieces of second preferential information, to cause a preferential margin of corresponding second preferential information of the first user terminal to be less than a preferential margin of corresponding second preferential information of the second user terminal; or respectively update and adjust, when the first distance difference information is less than the second distance difference information, the first preferential information of the first user terminal and the first preferential information of the second user terminal to obtain multiple pieces of second preferential information, to cause a preferential margin of corresponding second preferential information of the first user terminal to be greater than a preferential margin of corresponding second preferential information of the second user terminal.

In an implementation of the embodiments of this application, the amount adjustment unit is further configured to: determine a validity period of the electronic coupon information according to a permitted start time T0 for using the electronic coupon information and a permitted expiry time Tn for using the electronic coupon information, n being a positive integer greater than 1; and determine, when it is detected that the first time information reported by the user terminal is within the validity period, that the first time information reported by the user terminal satisfies the information amount adjustment policy.

In an implementation of the embodiments of this application, the amount adjustment unit is further configured to: obtain first time information Ti for using the electronic coupon information by a user logged into the server, i being a positive integer greater than 1; and update and adjust, if Ti approaches T0, the first preferential information to obtain second preferential information, to cause a preferential margin of the obtained second preferential information to be greater than a preferential margin of the first preferential information; or update and adjust, if Ti approaches Tn, the first preferential information to obtain second preferential information, to cause a preferential margin of the obtained second preferential information to be less than a preferential margin of the first preferential information.

In an implementation of the embodiments of this application, the obtaining unit is further configured to: obtain second geographical location information of the provider, and obtain distance difference information according to the first geographical location information of the user terminal and the second geographical location information of the provider. The amount adjustment unit is further configured to: determine a validity period of the electronic coupon information according to a permitted start time T0 for using the electronic coupon information and a permitted expiry time Tn for using the electronic coupon information, n being a positive integer greater than 1; and update and adjust, when the distance difference information is greater than a first threshold in the information amount adjustment policy and first time information Ti for using the electronic coupon information by a user logged into the server approaches Tn, the first preferential information to obtain second preferential information, to cause a preferential margin of the obtained second preferential information to be less than a preferential margin of the first preferential information; or update and adjust, when the distance difference information is less than a second threshold in the information amount adjustment policy and first time information Ti for using the electronic coupon information by a user logged into the server approaches T0, the first preferential information to obtain second preferential information, to cause a preferential margin of the obtained second preferential information to be greater than a preferential margin of the first preferential information.

It is noted herein that, the foregoing terminal devices (for example, the first terminal and the second terminal) may be such electronic devices as PCs, or be such portable electronic device as PADs, tablet computers, and handheld computers, or may be such intelligent mobile terminals as mobile phones, and are not limited thereto. The server may be an electronic device formed by using a cluster system, to implement functions of each unit, the units being combined or separately disposed. A client and the server each include at least a database for storing data and a processor for data processing, or each include a storage medium disposed in the server or a storage medium being independently disposed.

For the processor for data processing, the processing may be implemented by a microprocessor, a central processing unit (CPU), a digital signal processor (DSP), or a programmable gate array (FPGA). The storage medium includes an operating instruction. The operating instruction may be computer executable code. Each step of the information processing method in the embodiments of this application is implemented by using the operating instruction.

An instance of a hardware entity S11 including the terminal devices (for example, the first terminal and the second terminal) and the server is shown in FIG. 6. The apparatus includes a processor 61, a storage medium 62, and at least one external communications interface 63. The processor 61, the storage medium 62, and the external communications interface 63 are connected to each other by using a bus 64.

It is noted herein that descriptions of the terminal devices (for example, the first terminal and the second terminal) and the server are similar to the foregoing descriptions of the method, and the beneficial effects of the terminal devices and the server are the same as those of the method and are not described herein again. For technical details that are not disclosed in the client and server embodiments of this application, refer to the descriptions of the method embodiments of this application.

FIG. 8 is a schematic structural diagram of hardware of a server according to an embodiment of this application. The server may include a processor 801, a bus 802, and a memory 803. The processor 801 and the memory 803 are connected to each other by using the bus 802.

The memory 803 stores a sending unit 31, an obtaining unit 32, and an amount adjustment unit 33.

When being executed by the processor 801, the units stored in the memory 803 perform the same operations as those of the foregoing embodiments, and details are not described herein again.

According to the embodiments of this application, when it is detected whether location information between the first terminal and the second terminal and/or time information of using the electronic coupon information by the second terminal satisfies the information amount adjustment policy, if yes, the first information amount in the electronic coupon information is updated and adjusted to the second information amount, so that the sent electronic coupon information (for example, a card) may be adjusted according to a requirement, to prevent a user from being inaccurately located during pushing of the electronic coupon information (for example, the card), so that information can be shared continuously, and the processing efficiency and the response speed of information sharing are improved.

The embodiments of this application are described as follows by using an example of an actual application scenario:

According to the embodiments of this application, the application scenario is a technical solution in which a card or a coupon can be adjusted according to variable time and/or space, and a preferential manner that is dynamically changed according to time and space is provided. First, for the variable time, when issuing cards or coupons, a first terminal, for example, a merchant, may set a start time and an expiry time. Within the validity period, a discount that can be granted to a second terminal, for example, a common user, or referred to as a consumer, becomes smaller over time. That is, a time closer to the start time of using a card or a coupon indicates a larger discount, and a time closer to the expiry time of using a card or a coupon indicates a smaller discount. For the variable space, a server may first calculate a distance between a user and a merchant issuing the coupons, and then delivers different discounts according to different distances. For example, a discount granted to a user relatively distant from the merchant is less than that granted to a user relatively close to the merchant.

For the application scenario, by means of the related technology, the cards or coupons are issued by the merchant with fixed amounts. For example, for a payment platform, a user accesses an application home page of the payment platform, and may find discounts provided by nearby merchants. Generally, the discounts are used only when bills are paid by using the payment platform, and amounts are fixed. For example, for a group buying platform, a preferential form pushed by the platform mainly includes group buying and discounts for paying bills, and amounts are fixed. It can be learned that for the application scenario, discounts of preferential forms that are currently popular are usually fixed. For the application scenario, according to the embodiments of this application, a location relationship between a user and a merchant and a time for using a coupon by the user are considered in the preferential policy. The preferential forms may be changed according to time and space. That is, the policy may be updated, optimized, and adjusted at any time, to fully evacuate a potential consumption demand of the user. For example, because costs for users relatively distant from a merchant to consume in the merchant are relatively high, if larger discounts are delivered to the users, the users are greatly stimulated to consume in the merchant. At the same time, the merchant may attract more new consumers, to fully evacuate potential consumption demands of users, so that discounts granted by the users relatively distant from the merchant may be greater than discounts granted to users relatively close to the merchant. For example, when a user finds that a discount of a coupon becomes smaller over time, the user may be stimulated to use the coupon as soon as possible. The coupon subtly uses user psychology, and improves the interest of the coupon, thereby fully evacuating potential consumption demands of users.

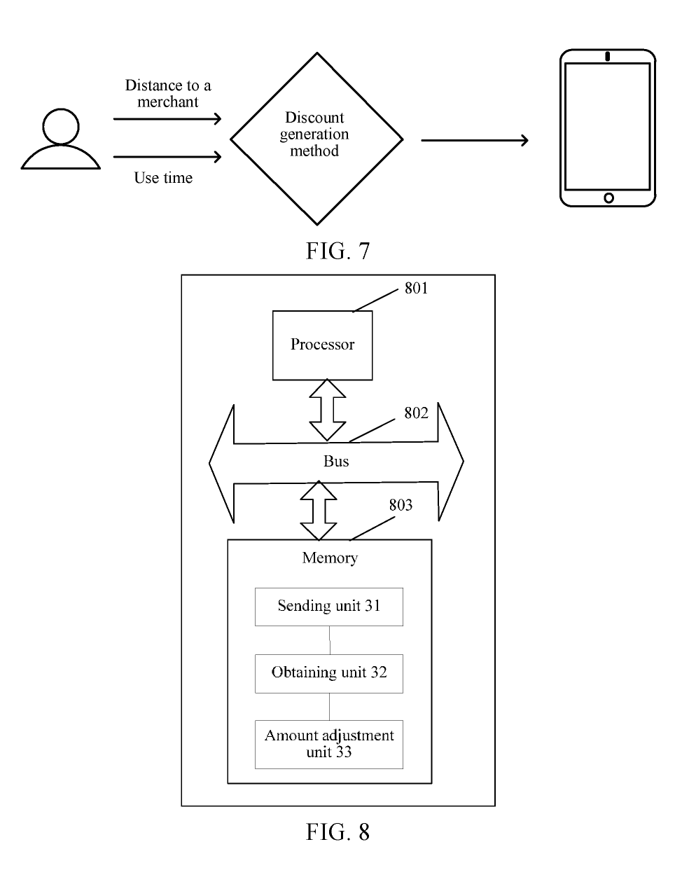

The solution in the embodiments of this application is used in the application scenario, the server may deliver a dynamically variable discount according to a distance between a user and a merchant and a time for using a coupon by the user, and the user may learn change of the discount from a coupon function of WeChat. Specifically, FIG. 7 shows a process of generating a discount. A discount seen by a user depends on a result being calculated based on a preferential method. The preferential method mainly includes two variables, that is, a distance between the user and a merchant and a time interval between a time for using a coupon by the user and a start time of the coupon. A longer distance indicates a smaller discount, and a shorter time interval indicates a larger discount. According to the embodiments of this application, different discounts are delivered according to different distances and different use times, so as to evacuate potential consumption demands of users to a greater extent, help the users to obtain more suitable preferential conditions, and attract more new users for a merchant.

In the several embodiments provided in this application, the disclosed device and method may be implemented in other manners. The described device embodiments are merely exemplary. For example, the unit division is merely logical function division and may be other division during actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the devices or units may be implemented in electronic, mechanical, or other forms.

The units described as separation parts may be or may not be physically separated. The part used as a display unit may be or may not be a physical unit. That is, the units may be located in a same place, or may be distributed to many network units. Some or all of the units need to be selected according to actual requirements to implement the purpose of the solution of the embodiments.

In addition, functional units in the embodiments of this application may be all integrated in a processing unit, each unit is separately used as a unit, or two or more units are integrated in a unit. The integrated unit may be implemented in a form of hardware, or may be implemented in form of hardware plus a software functional unit.

A person of ordinary skill in the art may understand that, some or all of steps for implementing the method embodiments may be implemented by using hardware related to a program instruction. The program may be stored in a computer-readable storage medium. When the program is executed, the steps including the method embodiments are performed. However, the storage medium includes various types of media that may store program code, for example, a mobile storage device, a read-only memory (ROM), a random access memory (RAM), a magnetic disk, or an optical disk.

Alternatively, when the foregoing integrated unit of this application is implemented in the form of a software functional unit and sold or used as an independent product, the integrated unit may be stored in a transitory or non-transitory computer-readable storage medium. Based on such an understanding, the technical solutions of the embodiments of this application essentially, or the part contributing to the existing technology may be implemented in a form of a software product. The computer software product is stored in a storage medium and includes several instructions for instructing a computer device (which may be a personal computer, a server, a network device, or the like) to perform all or some of the methods described in the embodiments of this application. The foregoing storage medium includes: any media that can store program code, such as a mobile storage device, a ROM, a RAM, a magnetic disk, or an optical disc.

What is claimed is:

1. An information processing method of a server, the method comprising:
sending, to a user terminal, electronic information obtained from a third-party application system through an information service interface, the electronic information including a numerical value and provider information;
obtaining at least one of first geographical location information of the user terminal or first time information reported by the user terminal;
determining whether one of the at least one of the first geographical location information of the user terminal or the first time information reported by the user terminal satisfies an adjustment condition;
updating, when one of the at least one of the first geographical location information or the first time information satisfies the adjustment condition, the numerical value in the electronic information; and
sending the updated numerical value of the electronic information to the user terminal.

2. The method according to claim 1, wherein the determining comprises:
obtaining second geographical location information of the provider;
obtaining a distance between the provider and the user terminal according to the first geographical location information of the user terminal and the second geographical location information of the provider; and
determining whether the distance is within a preset distance range.

3. The method according to claim 2, wherein the updating comprises:
decreasing, when the distance is greater than a first threshold of the adjustment condition, the numerical value; and
increasing, when the distance is less than a second threshold of the adjustment condition, the numerical value.

4. The method according to claim 1, wherein the sending comprises:
sending the electronic information to a first user terminal and a second user terminal that are logged into the server respectively, the electronic information sent to the first user terminal including a first numerical value and the electronic information sent to the second user terminal including a second numerical value; wherein
the determining comprises:
obtaining first geographical location information of the first user terminal and first geographical location information of the second user terminal, respectively;
obtaining second geographical location information of the provider, and obtaining a first distance according to the first geographical location information of the first user terminal and the second geographical location information of the provider; and
obtaining a second distance according to the first geographical location information of the second user terminal and the second geographical location information of the provider; and
the updating comprises:
updating, when the first distance is greater than the second distance, the first numerical value and the second numerical value so that a difference between the first numerical value and the updated first numerical value is lower than a difference between the second numerical value and the updated second numerical value; and
updating, when the first distance is less than the second distance, the first numerical value and the second numerical value so that a difference between the first numerical value and the updated first numerical value is higher than a difference between the second numerical value and the updated second numerical value.

5. The method according to claim 1, wherein the determining comprises:
determining a validity period of the electronic information according to a permitted start time T0 for using the electronic information and a permitted expiry time Tn for using the electronic information, n being a positive integer greater than 1; and
determining, whether the first time information reported by the user terminal is within the validity period.

6. The method according to claim 5, wherein the updating comprises:
obtaining first time information Ti for using the electronic information when a user is logged into the server, i being a positive integer greater than 1; and
increasing, when Ti approaches T0, the numerical value; and
decreasing, when Ti approaches Tn, the numerical value.

7. The method according to claim 1, wherein the updating comprises:
obtaining second geographical location information of the provider, and obtaining a distance between the user and the provider according to the first geographical location information of the user terminal and the second geographical location information of the provider;
determining a validity period of the electronic information according to a permitted start time T0 for using the electronic information and a permitted expiry time Tn for using the electronic information, n being a positive integer greater than 1;
decreasing, when the distance between the user and the provider is greater than a first threshold of the adjustment condition and first time information Ti for using the electronic information by a user logged into the server approaches Tn, the numerical value; and
increasing, when the distance between the user and the provider is less than a second threshold of the adjustment condition and first time information Ti for using the electronic information by a user logged into the server approaches T0, the numerical value.

8. A server, comprising:
processing circuitry configured to
send, to a user terminal, electronic information obtained from a third-party application system through an information service interface, the electronic information including a numerical value and provider information;
obtain at least one of first geographical location information of the user terminal or first time information reported by the user terminal;
determine whether one of the at least one of the first geographical location information or the first time information reported by the user terminal satisfies an adjustment condition;
update, when one of the at least one of the first geographical location information or the first time information satisfies the adjustment condition, the numerical value in the electronic information; and
send the updated numerical value of the electronic information to the user terminal.

9. The server according to claim 8, wherein the processing circuitry is further configured to:
obtain second geographical location information of the provider, and obtain a distance between the provider and the user terminal according to the first geographical location information of the user terminal and the second geographical location information of the provider; and
determine, whether the distance between the provider and the user terminal is within a preset distance range.

10. The server according to claim 9, wherein the processing circuitry is further configured to:
decrease, when the distance is greater than a first threshold of the adjustment condition, the numerical value; and
increase, when the distance is less than a second threshold of the adjustment condition, the numerical value.

11. The server according to claim 8, the processing circuitry is further configured to:
send the electronic information to a first user terminal and a second user terminal that are logged into the server respectively, the electronic information sent to the first user terminal including a first numerical value and the electronic information sent to the second user terminal including a second numerical value;
obtain first geographical location information of the first user terminal and first geographical location information of the second user terminal, respectively;
obtain second geographical location information of the provider, and obtain a first distance between the provider and the first user terminal according to the first geographical location information of the first user terminal and the second geographical location information of the provider; and
obtain a second distance between the provider and the second user terminal according to the first geographical location information of the second user terminal and the second geographical location information of the provider; and
update, when the first distance is greater than the second distance, the first numerical value and the second numerical value so that a difference between the first numerical value and the updated first numerical value is lower than a difference between the second numerical value and the updated second numerical value; and
update, when the first distance is less than the second distance, the first numerical value and the second numerical value so that a difference between the first numerical value and the updated first numerical value is higher than a difference between the second numerical value and the updated second numerical value.

12. The server according to claim 8, wherein the processing circuitry is further configured to:
determine a validity period of the electronic information according to a permitted start time T0 for using the electronic information and a permitted expiry time Tn for using the electronic information, n being a positive integer greater than 1; and
determine, whether the first time information reported by the user terminal is within the validity period.

13. The server according to claim 12, wherein the processing circuitry is further configured to:
obtain first time information Ti for using the electronic information when a user is logged into the server, i being a positive integer greater than 1; and
increase, when Ti approaches T0, the numerical value; and
decrease, when Ti approaches Tn, the numerical value.

14. The server according to claim 8, wherein the processing circuitry is further configured to:
obtain second geographical location information of the provider, and obtain a distance between the user terminal and the provider according to the first geographical location information of the user terminal and the second geographical location information of the provider;
determine a validity period of the electronic information according to a permitted start time T0 for using the electronic information and a permitted expiry time Tn for using the electronic information, n being a positive integer greater than 1; and
decrease, when the distance is greater than a first threshold of the adjustment condition and first time information Ti for using the electronic information when a user is logged into the server approaches Tn, the numerical value; and
increase, when the distance is less than a second threshold of the adjustment condition and first time information Ti for using the electronic information when a user is logged into the server approaches T0, the numerical value.

15. A non-transitory computer-readable storage medium storing a computer program, the computer program being used for performing a method, the method comprising:
sending, to a user terminal, electronic information obtained from a third-party application system through an information service interface, the electronic information including a numerical value and provider information;
obtaining at least one of first geographical location information of the user terminal or first time information reported by the user terminal;
determining whether one of the at least one of the first geographical location information or the first time information reported by the user terminal satisfies an adjustment condition;
updating, when one of the at least one of the first geographical location information or the first time information satisfies the adjustment condition, the numerical value in the electronic information; and
sending the updated numerical value of the electronic information to the user terminal.
